(19) United States
(12) Patent Application Publication
(10) Pub. No.: US 2015/0294324 A1
(43) Pub. Date: Oct. 15, 2015

(54) SYSTEM AND METHOD FOR ELECTRONICALLY COLLECTING DATA ASSOCIATED WITH PRODUCTS OR SERVICES PURCHASED BY A PLURALITY OF CONSUMERS

(71) Applicant: Guglielmo Luigi RONCHAIL, Torino (IT)

(72) Inventor: Guglielmo Luigi Ronchail, Torino (IT)

(21) Appl. No.: 14/439,089

(22) PCT Filed: Nov. 15, 2013
(86) PCT No.: PCT/IB2013/060159

§ 371 Date: Apr. 28, 2015

(30) Foreign Application Priority Data
Nov. 15, 2012 (IT) TO2012A000992

(51) Int. Cl. G06Q 30/02

(52) U.S. Cl. CPC G06Q 30/0201; G06Q 30/0222

(57) ABSTRACT

A system and a method for the incentivized collection of data associated with the purchase of products or services by a plurality of consumers. The incentivization primarily involves the award of prizes, according to particular predetermined procedures, to consumers who participate, at no cost, in the data collection. These procedures for awarding prizes are determined in such a way as to stimulate the increasingly enthusiastic, intensive and frequent participation of consumers in the data collection.

### BACKGROUND OF THE INVENTION

1. Field of the Invention

The present invention relates to a system and a method for electronically collecting data, and more specifically for the incentivized collection of data associated with products or services purchased by a plurality of consumers.

2. Background

Market research relating to the consumption and/or purchasing of products and to the use of services is of great importance.

Two primary types of conventional market surveys can be distinguished, namely quantitative and qualitative surveys.

Quantitative market surveys can provide a statistical representation of the consumption and/or purchasing of a population based on the data collected in relation to a given sample. At present, these market surveys obtain the relevant commercial information from the collection of the output data of points of sale (the sell-out) and from the purchases made by them (the sell-in). If the survey is focused directly on the consumer's behaviour and habits, which are aspects ignored by point-of-sale data collection, use is made of surveys conducted by means of questionnaires with closed-ended questions, completed in the course of interviews carried out face to face, by telephone, by post or by the internet. These surveys are evidently limited in space and time, yield rather unreliable answers and are based on samples which are inevitably small because of the high operating costs.

On the other hand, market surveys of the qualitative type are conventionally conducted by means of questionnaires with open-ended answers, completed not only in face-to-face, telephone, postal or internet-based surveys, but also by using what are known as “focus groups”, observations and “desk research”.

As an alternative to the conventional methods, qualitative surveys can also be conducted using social media or other digital platforms, by “tracking” users' interests on line. Both of the aforementioned qualitative approaches can be used to deduce consumers' interests and propensities and to estimate their preferences, without obtaining any statistical representation. Instead, the emotional and symbolic characteristics of consumers are analysed, in order to obtain preparatory information for quantitative research for the purpose of identifying themes to be covered by the corresponding questionnaires, together with exploratory information providing an indication of the characteristics of product and/or brand perception, as well as useful information for “creatives” in their choice of trade names or brands, and diagnostic information which can be used subsequently for a more thorough investigation of specific themes.

Qualitative market surveys suffer from the inevitable discrepancy existing between what consumers say and what they actually do, in other words between items that are attractive and those that are actually bought.

The aforementioned limitations of both types of market survey demonstrate the need for a procedure for collecting objective data on consumers' behaviour, using the systems provided by globalization in order to meet the requirements of a global economy.

It is therefore desirable to provide a new procedure for collecting market data, which will make it possible:

to shift the focus of objective data collection from the point of sale to the end consumer,

to base the data collection on an objective data element (such as the consumption and/or purchase of a product and/or the enjoyment of a service), to ensure the reliability of the data;

to eliminate spatial and temporal limitations, making it possible to monitor the development of behaviour over time and in different geographical areas;

to construct “profiles” of the consumers, possibly without barriers between different market sectors;

to base the survey on a large and stable sample, to ensure the high statistical reliability of the data;

to standardize the data acquired, in such a way that data acquired in different countries are comparable with each other and can be aggregated if required; and

to use the same source for commercial analysis and corporate strategy.

The cost of the data collection must also be reasonably low; in particular, it must not increase with a rise in the number of consumers from whom data is obtained.

### SUMMARY OF THE INVENTION

The present invention relates to a system and a method for the incentivized collection of data associated with the purchase of products or services by a plurality of consumers. The incentivization primarily consists in the award of prizes, according to particular predetermined procedures, to consumers who participate, at no cost, in the data collection. As described more fully below, these procedures for awarding prizes are determined in such a way as to stimulate the increasingly enthusiastic, intensive and frequent participation of consumers in the data collection.

In a system of this type, however, some participating consumers may attempt to improve their chances of winning prizes by fraudulent means, which may compromise the expected results of the creation and operation of the system by generating erroneous data collection results, and may lead to the award of prizes to dishonest consumers who do not deserve them.

The object of the present invention is therefore to resolve the technical problem of providing a method and an electronic system for the simple and reasonably inexpensive implementation of a new and innovative market survey method for the collection of data relating to products or services purchased by a plurality of consumers, while preventing the possibility of fraudulent participation, or limiting it as far possible.

This and other objects are achieved according to the invention with a method whose principal characteristics are described herein.

This method comprises, at the location of each consumer participating in the collection and/or at one or more points of purchase of products or services, the operations of:

electronically acquiring and communicating registration data identifying a consumer who intends to participate in the collection, and

electronically generating, on each purchase, identification data uniquely associated with each product or service purchased by the consumer, and transmitting purchase information combining data identifying the purchasing consumer with said data identifying the purchased product or service.

At a central electronic data collection and processing unit, the method comprises the operations of:

receiving and storing registration data on the consumer participating in the collection, and subsequently the purchase information progressively transmitted, in a predetermined period of time, by the registered consumers and/or by said one or more points of purchase;

checking and, if appropriate, validating, for each purchase information element received, the data identifying the purchased products or services, and allocating at least one entitlement or credit to each registered consumer who sends, directly or via said one or more points of purchase, a purchase information element whose identification data have been validated.

In respect of a purchase of a product or service which is provided with a respective unique visible or legible identification code, in order to generate the corresponding purchase information, said identification code is scanned or read, and data representative of this code are generated.

In respect of a purchase of a product or service which is not provided with a respective unique visible or legible identification code, the central unit is conveniently requested to issue a corresponding assigned unique identification code which (at the location of the consumer participating in the collection and/or at said one or more points of purchase) is associated inseparably with the purchased product or service, the generation of the corresponding purchase information comprising the scanning or reading of said associated unique identification code that has been assigned, and the generation of corresponding data.

The aforesaid object is also achieved according to the invention by means of an electronic system whose salient characteristics are defined in the attached Claim 6.

This system comprises, at the location of each consumer participating in the collection and/or at one or more points of purchase of said products or services:

electronic means for acquiring and communicating data, designed to acquire and transmit registration data identifying a consumer who intends to participate in the collection;

data generating means designed to generate identification data uniquely associated with each product or service purchased by the consumer, said data generating means being connected or connectable to the data acquisition and communication means which are also designed to generate and transmit purchase information combining data identifying the purchasing consumer with said data identifying the purchased product or service.

The system further comprises at least one electronic central unit (ECU) for data collection and processing, including:

electronic receiving and storing means designed to receive and store the registration data on the consumer participating in the collection, and subsequently the purchase information progressively transmitted, in a predetermined period of time, by the registered consumers and/or by said one or more points of purchase via the respective data acquisition and communication means, and

electronic processing and operation control means connected to or associated with said receiving and storing means and designed to check and, if appropriate, validate, for each purchase information element received, the data identifying the purchased products or services, and to allocate at least one entitlement or credit to each registered consumer who sends, directly or via said one or more points of purchase, a purchase information element whose identification data have been validated.

In respect of a purchase of a product or service which is provided with a respective unique visible or legible identification code, said data generating means comprise scanning or reading means adapted to scan or read said unique identification code and to generate data representative of said code.

In respect of a purchase of a product or service not provided with a respective unique visible identification code, said acquisition and communication means are designed to request the central unit to allocate a corresponding assigned unique identification code, and then to receive said code.

An associator device is provided at the location of each consumer participating in the collection and/or at said one or more points of purchase, this device being adapted to associate inseparably the assigned unique identification code, allocated and transmitted by the central unit, with the purchased product or service, and said data generating means comprise scanning or reading means adapted to generate data representative of said assigned unique identification code.

Where market research is concerned, the cost of data collection is the factor which initially determines the feasibility or otherwise of the project.

Furthermore, consumers are naturally inclined to participate in a survey of their consumption by documenting their purchases if they derive some profit from their participation in a survey.

Since it would be impossible to provide significant individual remuneration to all the consumers involved in a survey without causing an unacceptable rise in costs, the procedure forming the basis of the method and electronic system according to the present invention is designed to remunerate the consumers involved by appealing to their irrational side.

Indeed, it is known that a majority of the population in many countries participates enthusiastically and regularly in prize games, without any substantial distinction as regards sex or social class. It is also known that many people live in expectation of an event, usually undefined, exceptional and extraordinary, unforeseen but hoped for, that might in some way radically change their lives.

The winning of a prize, particularly a substantial sum of money which can in itself be “life-changing”, is the extraordinary event, specific and definite in this case, that all “players”, including “pathological” ones, expect as a result of their participation in a game.

As mentioned above, the data collection procedure underlying the method and electronic system according to the invention is based on the consideration that good results may be achieved by providing an incentive to participate in a collection of market data by means of participation in a game, particularly a competition in which a prize of high value is awarded.

### BRIEF DESCRIPTION OF THE DRAWINGS

Other characteristics and advantages of the invention will become clear from the following detailed description, which is given purely by way of non-limiting example, with reference to the attached drawings, in which:

FIG. 1 is a schematic perspective view of an electronic system according to the present invention;

FIG. 2 is a representation, in the form of a block diagram, of a central data collection and processing system according to the present invention; and

FIG. 3 is a flow diagram providing a qualitative illustration of an execution cycle of a method according to the present invention.

### DETAILED DESCRIPTION OF THE INVENTION

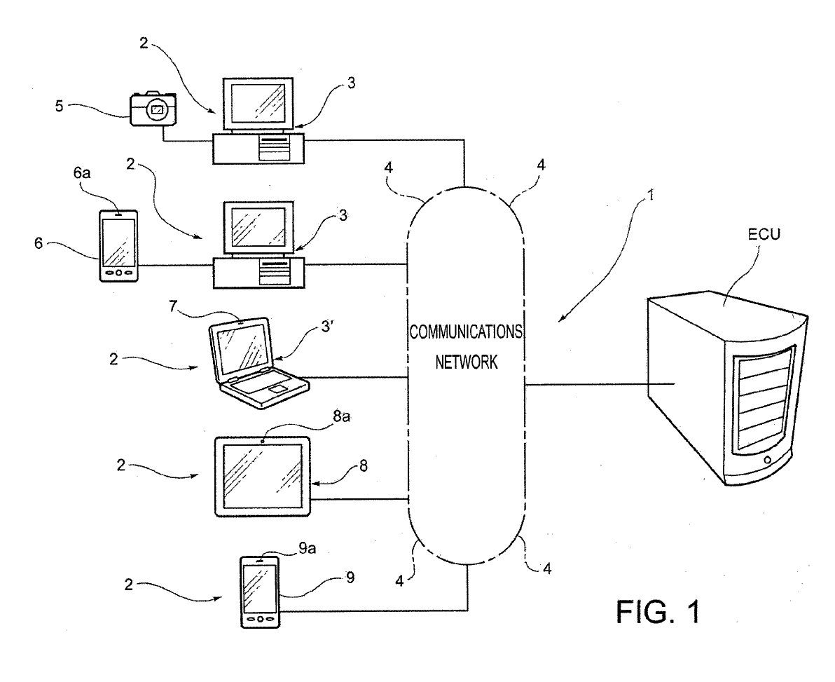

In FIG. 1, the number 1 indicates the whole of a system according to the present invention for electronically collecting data associated with products or services purchased by a plurality of consumers.

This system essentially comprises a central electronic data collection and processing unit (ECU), implemented with known hardware.

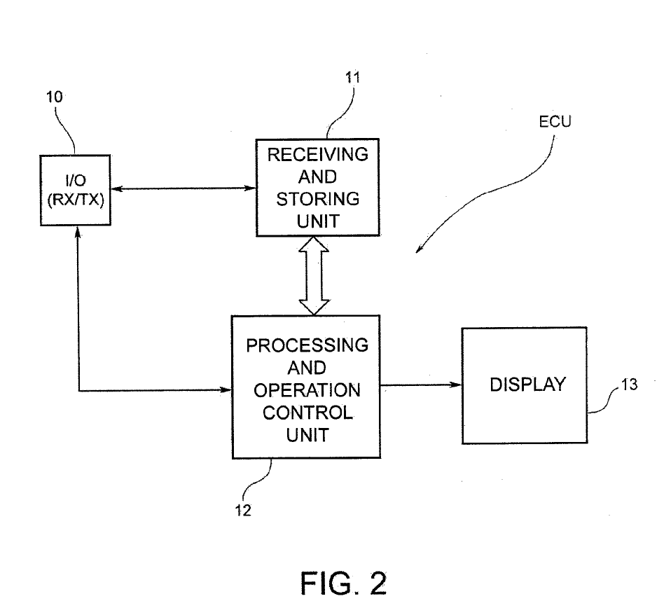

As shown in the block diagram of FIG. 2, this unit essentially comprises an input/output interface 10, communicating with a data receiving and storing unit 11, which in turn communicates with a processing and operation control unit 12, with which a display device 13 may be associated.

The processing and operation control unit 12 controls and drives the operation of the input/output unit 10 and of the receiving and storing unit 11.

With reference to FIG. 1, at the location of each consumer participating in the collection and/or at one or more points of purchase of products or services (at a supermarket check-out, for example) there is a respective electronic apparatus indicated as a whole by 2.

The electronic apparatus 2 of each consumer who intends to participate in the collection and/or of said one or more points of purchase essentially comprises electronic data acquisition and communication devices, adapted to acquire and transmit registration data identifying the consumer, and devices for generating identification data which uniquely identify each product or service purchased by the consumer, these devices being connected or connectable to the data acquisition and communication devices.

FIG. 1 shows five possible (non-limiting) exemplary embodiments of the electronic apparatus 2 which can be used at the location of a consumer participating in the collection and/or at said one or more points of purchase.

Starting from the top of the drawing, in the first two examples of FIG. 1 each electronic data acquisition and communication device consists of a desktop personal computer 3, adapted to access a communications network 4, particularly the internet.

In the uppermost example of FIG. 1, the device used by the consumer for generating data uniquely identifying each product or service purchased is, for example, a digital camera or video camera 5, connected to the personal computer 3. The procedures for generating the data which uniquely identify each product or service purchased by the consumer are described more fully below.

In the second example from the top in FIG. 1, the identification data generator device is a mobile telephone 6, which is connected or connectable to the personal computer 3 and is provided with a digital camera 6a.

In the middle example of FIG. 1, the electronic apparatus 2 comprises a personal computer 3′ of the portable type, enabled to communicate via the network 4 and provided with a webcam 7.

In the penultimate example of FIG. 1, the electronic apparatus 2 comprises what is known as a “tablet” 8, provided with a photographic lens 8a and also enabled to communicate via the network 4.

Finally, in the last example of FIG. 1, the electronic apparatus 2 comprises a simple mobile telephone of the smartphone type 9, enabled to communicate via the network 4 and provided with a photographic lens 9a.

The examples described above are given solely for guidance and are not limiting in any way.

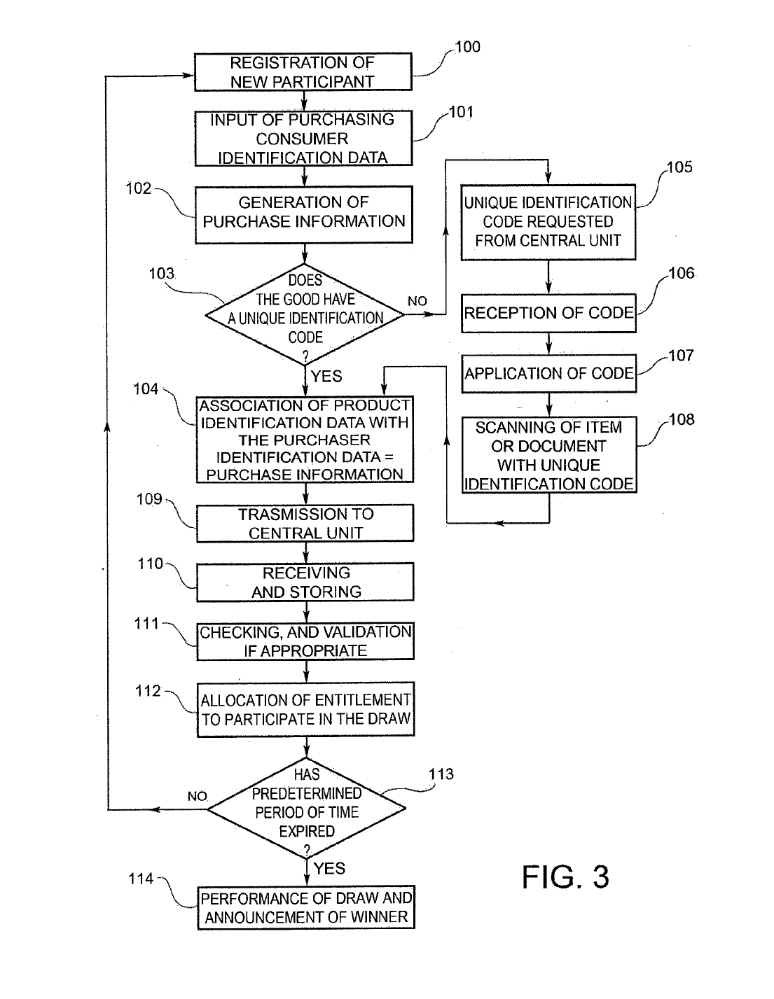

The operation of the system according to the invention will now be described with reference to the previously described FIGS. 1 and 2, and to the flow diagram of FIG. 3.

The operation starts with the registration of a consumer who intends to participate in the collection (box 100 in FIG. 3).

In this step, it is necessary to reconcile two at least partially opposing requirements, namely:

to identify reliably the participating consumer, by the acquisition of his personal data, and

to safeguard the privacy of the participants as absolutely as possible; to this end, the registration data archive and its management are conveniently separated from the archive for the collection and management of data relating to the consumption and/or purchasing of products and/or services.

Each consumer intending to participate in the collection can register himself as a new participant by using the acquisition and communication device that he holds, such as a personal computer 3 or 3′, a tablet 8, a smartphone 9, or the like. The registration data on the participating consumer are thus transferred to the central unit ECU via the communications network 4.

Alternatively, the consumer intending to register as a participant in the collection may use the point of purchase of products or services, or any one of such points, equipped with an electronic apparatus of the type described above.

By way of example, the input of the registration data may include the completion of a prepared form containing the following information:

surname and forename/forenames, place and date of birth, full home address, gender, height, body weight, marital status, number of members of any family group (or equivalent) living with the consumer, details of a freely chosen, freely modifiable password, and consent to the electronic processing of these data.

If desired, it may be specified that the consumer must send the image or images of an official identity document showing his personal data in order to register as a new participant.

On completion of the transmission of all the data and their acquisition by the receiving and storing unit 11 of the central unit ECU, the consumer who has requested his registration is given confirmation of this registration. This consumer may also be given a personal identification code.

The central unit ECU may also be designed to allocate an electronic mail address to the participating consumer, in which the allocated identification code forms the identifier, while the name of the system is the domain. This provides further protection of the participant's privacy (in the electronic mail addresses that are normally used, the surname and possibly also the forename of the person are very often deducible from the identifier).

The ECU is also designed to analyse and store the data on the registered consumer for the purposes of market research: to this end, the data relevant to the market survey are loaded into suitable forms.

After being registered as a participant, the consumer, on each purchase of a good, which may be a product or a service, must notify this to the central collection and processing unit ECU, in the form of purchase information elements generated by procedures described below (FIG. 3, box 102).

This takes place by means of the available electronic apparatus 2, and in particular by means of what were defined above as data acquisition and communication devices, such as a personal computer 3 or 3′, a tablet 8, or a smartphone 9.

These devices are adapted to acquire and transmit to the ECU unit the purchase information elements, which identify the purchasing consumer (FIG. 3, box 101) and identify the specific product or service purchased. The purchasing consumer can be identified by the indication of the code previously allocated to him by the central unit ECU in the course of registration.

In order to avoid fraudulent operations of repeated notification to the central unit ECU of a single product and/or service that has already been notified, or even of a product and/or service that has never been purchased or does not exist, in the system according to the invention devices for generating data uniquely identifying each specific product or service purchased by the consumer are associated with the aforesaid electronic data acquisition and communication devices, at the location of each consumer participating in the collection and/or at said one or more points of purchase.

In the examples described above with reference to FIG. 1, these identification data generator means comprise the camera 5, or the mobile telephone 6, or the webcam 7 or 8a, or the mobile telephone with a camera 9.

Other possible identification data generator devices may include scanners, optical and/or magnetic code readers of known types, or the like.

This step in the operation of the system includes two different execution procedures, depending on whether the purchased good is or is not provided at source with a respective visible or readable unique identification code (FIG. 3, box 103).

In the case of a good that has already been provided with a respective unique identification code, each of the aforesaid devices for generating data uniquely identifying each product or service simply consists of a scanning or reading apparatus adapted to scan or read the unique identification code that distinguishes each specific good, and to generate digital data representative of said code. These data, associated with the identification data of the purchasing consumer, form what is defined in the present context as “purchase information”, which is sent to the central unit ECU via the network 4 (FIG. 3, box 104).

However, if the purchased good has not been provided with its own specific unique identification code, the central unit ECU is requested, via the electronic apparatus 2 held by the purchasing consumer or present at the point of purchase, to issue an assigned unique identification code (FIG. 3, box 105). The central unit ECU generates this code and transmits it to the electronic apparatus 2 that has requested it, and that receives it (FIG. 3, box 106).

The assigned unique identification code received in this way must then be associated inseparably with the product or with its packaging. If the good takes the form of a service, the unique identification code that is received may be associated inseparably with a document uniquely related to the purchased service, such as the debit invoice for the service.

However, there are other possible procedures for inseparably associating the identification code, such as the use of labels printed with indelible ink and applied to the product or to a document by high-strength adhesives.

If the assigned identification code is associated with, or applied to, the product or purchase document by the consumer, the latter may carry out the scan of at least one image of the product or document to which the assigned unique identification code has been associated or to which it has been applied (FIG. 3, box 108). This operation can be carried out by means of a digital camera or video camera, a webcam, a scanner, or the like.

The image data generated in this way are used as unique identification data which can then be associated with the identification data of the purchasing consumer (FIG. 3, box 104) in order to form the purchase information that is sent to the central unit ECU via the network 4 (FIG. 3, box 109).

Optionally, the procedure for requesting an assigned identification code from the central unit ECU and for associating it inseparably with the product or document can also be applied to products and/or documents that have already been provided at source with their own identification code, in order to provide a further identification code to improve the security of the system against fraudulent attempts to obtain entitlements or credits.

The purchase information transmitted towards the ECU is received, stored and then analysed by the latter (FIG. 3, box 110).

In particular, the processing and operation control unit 12 of the central unit ECU is designed to check the reliability of the identification data of the purchased products or services, and then to validate them if appropriate (FIG. 3, box 111).

Following the positive outcome of the check and the consequent validation, the consumer who has sent the purchase information element is allocated at least one entitlement or credit, for example an entitlement to participate in a real or virtual draw (FIG. 3, box 112). Participation in this draw is limited to registered consumers who, within a predetermined period of time, have sent at least one checked and validated purchase information element.

The central unit ECU can conveniently be designed to allocate more than one entitlement or credit to a consumer participating in the collection, for each transmitted, checked and validated purchase information element, when predetermined conditions are met, for example the consumer's membership of some body or group of particular interest for the purposes of the market research.

The central unit ECU can also be designed to manage a site in the communications network 4, in which at least one personal page is generated for each consumer participating in the research, this page being accessible by the consumer by means of a personal code. This page may be used by the consumer for the input of the purchase information and for periodically checking the number of entitlements or credits accumulated.

The operation proceeds cyclically as described above, until the predetermined period of time has expired (FIG. 3, box 113), after which the processing and operation control unit 12 performs a draw electronically, in a random or pseudo-random manner, among all the registered consumers to whom said entitlements or credits have been allocated in said predetermined period of time, and the winner is finally announced (FIG. 3, box 114).

On completion of the draw, and before the announcement of the winner and the award of the prize, examination and checking procedures may conveniently be carried out in order to avoid the award of the prize to a consumer who has participated fraudulently in the collection and in the final draw.

Conveniently, the final draw may include the drawing of a predetermined number of potential winners: the first name drawn will be that of the actual winner if the outcome of the examinations and checks is positive, but the others may be declared to be winners if the examinations and checks performed on the previously drawn names lead to a negative outcome.

Clearly, provided that the principle of the invention is retained, the forms of application and the details of embodiment can be varied widely from what has been described and illustrated purely by way of non-limiting example, without thereby departing from the scope of protection of the invention as defined by the attached claims.

1.-10. (canceled)

11. Method for electronically collecting data relating to products or services purchased by a plurality of consumers, comprising the steps of:
at the location of each consumer participating in the collection and/or at one or more points of purchase of said products or services:
electronically acquiring and communicating registration data identifying a consumer who intends to participate in the collection, and
electronically generating, on each purchase, identification data uniquely associated with each product or service purchased by the consumer, and transmitting purchase information combining data identifying the purchasing consumer with said data identifying the purchased product or service; and
at one or more central electronic data collection and processing units (ECU):
receiving and storing registration data on the consumer participating in the collection, and subsequently the purchase information progressively transmitted, in a predetermined period of time, by the registered consumers and/or by said one or more points of purchase;
checking and, if appropriate, validating, for each purchase information element received, the data identifying the purchased products or services, and allocating at least one entitlement or credit to each registered consumer who sends, directly or via said one or more points of purchase, a purchase information element whose identification data have been validated; and wherein
in respect of a purchase of a product or service which is provided with a respective unique visible or legible identification code, in order to generate the corresponding purchase information, said identification code is scanned or read, and data representative of this code are generated, and
in respect of a purchase of a product or service which is not provided with a respective unique visible or legible identification code, the central unit (ECU) is requested to issue a corresponding assigned unique identification code which (at the location of the consumer participating in the collection and/or at said one or more points of purchase) is associated inseparably with the purchased product or service, the generation of the corresponding purchase information comprising the scanning or reading of said associated unique identification code that has been assigned, and the generation of corresponding data.

12. Method according to claim 11, wherein, in respect of a product or service which is not provided with a respective unique visible or legible identification code, the central unit (ECU) is requested to issue a corresponding further assigned unique identification code which, at the location of the consumer participating in the collection and/or at said one or more points of purchase, is associated inseparably with the purchased product or service; the generation of the corresponding purchase information comprising the scanning or reading of said associated unique identification code that has been assigned, and the generation of corresponding data.

13. Method according to claim 11, wherein said entitlement or credit comprises at least one entitlement to participate in a real or virtual draw, participation in which is limited to the registered consumers to whom at least one said entitlement or credit has been allocated, said draw including the assignment of at least one prize of predetermined value to the consumer winning the draw on a predetermined date following the end of said predetermined period of time.

14. Method according to claim 11, wherein said electronic central unit (ECU) is designed to allocate more than one entitlement or credit to the consumer for each purchase information element when at least one predetermined condition is met.

15. Method according to claim 13, wherein said electronic central unit (ECU) is designed to perform a draw in a random or pseudo-random manner among all the registered consumers to whom entitlements or credits have been allocated in said predetermined period of time.

16. System for electronically collecting data associated with products or services purchased by a plurality of consumers, comprising:
at the location of each consumer participating in the collection and/or at one or more points of purchase of said products or services:
electronic means for acquiring and communicating data, designed to acquire and transmit registration data identifying a consumer who intends to participate in the collection;
data generating means designed to generate identification data uniquely associated with each product or service purchased by the consumer, said data generating means being connected or connectable to the data acquisition and communication means which are also designed to generate and transmit purchase information combining data identifying the purchasing consumer with said data identifying the purchased product or service;
the system further comprising at least one electronic central unit (ECU) for data collection and processing, including:
electronic receiving and storing means designed to receive and store the registration data on the consumer participating in the collection, and subsequently the purchase information progressively transmitted, in a predetermined period of time, by the registered consumers and/or by said one or more points of purchase via the respective data acquisition and communication means, and
electronic processing and operation control means) connected to or associated with said receiving and storing means and designed to check and, if appropriate, validate, for each purchase information element received, the data identifying the purchased products or services, and to allocate at least one entitlement or credit to each registered consumer who sends, directly or via said one or more points of purchase, a purchase information element whose identification data have been validated; and wherein
in respect of a purchase of a product or service which is provided with a respective unique visible or legible identification code, said data generating means comprise scanning or reading means adapted to scan or read said unique identification code and to generate data representative of said code, and wherein
in respect of a purchase of a product or service not provided with a respective unique visible identification code, said acquisition and communication means are designed to request the central unit (ECU) to allocate a corresponding assigned unique identification code, and then to receive said code;
an associator device being available at the location of each consumer participating in the collection and/or at said one or more points of purchase, this device being adapted to associate inseparably the assigned unique identification code, allocated and transmitted by the central unit (ECU), with the purchased product or service; said data generating means comprising scanning or reading means adapted to generate data representative of said assigned unique identification code.

17. System according to claim 16, wherein, in respect of a purchase of a product or service provided with a respective unique visible or legible identification code, said acquisition and communication means are designed to request the central unit (ECU) to allocate a corresponding further assigned unique identification code, and then to receive said further code;
an associator device being available at the location of each consumer participating in the collection and/or at said one or more points of purchase, this device being adapted to associate inseparably said further assigned unique identification code, allocated and transmitted by the central unit (ECU), with the purchased product or service; said data generating means comprising scanning or reading means adapted to generate data representative of said further assigned unique identification code.

18. System according to either of claim 16, wherein said electronic unit (ECU) is designed to allocate entitlements or credits comprising at least one entitlement to participate in a real or virtual draw, participation in which is limited to the registered consumers to whom at least one said entitlement or credit has been allocated, said draw including the assignment of at least one prize of predetermined value to the consumer winning the draw on a predetermined date following the end of said predetermined period of time.

19. System according to claim 16, wherein said electronic central unit (ECU) is designed to allocate more than one entitlement or credit to the consumer for each purchase information element when at least one predetermined condition is fulfilled.

20. System according to claim 16, wherein said electronic central unit (ECU) is designed to perform a draw in a random or pseudo-random manner among all the registered consumers to whom entitlements or credits have been allocated in said predetermined period of time.
